(19) United States
(12) Patent Application Publication
(10) Pub. No.: US 2016/0210655 A1
(43) Pub. Date: Jul. 21, 2016

(54) Managing Content Item Presentation Based On Cost of Presenting the Content Items and Completion of Objectives Associated with the Content Items

(71) Applicant: Facebook, Inc., Menlo Park, CA (US)

(72) Inventors: Peter Michael Cottle, Palo Alto, CA (US); Connor C. Hayes, San Francisco, CA (US); Atol Fortin de Oliveira, San Francisco, CA (US); Palash Agarwal, Sunnyvale, CA (US); Adrian Ivo Kuhn, Menlo Park, CA (US)

(21) Appl. No.: 14/601,096

(22) Filed: Jan. 20, 2015

(51) Int. Cl. G06Q 30/02

(52) U.S. Cl. CPC G06Q 30/0244; G06Q 30/0273; G06Q 30/0277

(57) ABSTRACT

An advertising campaign maintained by an online system includes an objective, and the online system determines a metric for the advertising campaign based the objective. For example, the online system determines the metric as a ratio of an amount received from an advertiser for presenting the advertising campaign to a number of completed objectives associated with the advertising campaign. Additional advertising campaigns including the objective are identified, and the online system determines metrics for the additional advertising campaigns. The online system compares the metric for the advertising campaign to the metrics for the additional advertising campaign and communicates information to the advertiser based on the comparison.

### BACKGROUND

The disclosure generally relates to online systems, and more specifically to accounting for objectives for presenting content when presenting content via an online system.

An online system allows users to connect to and to communicate with other users of the online system. Users create profiles on an online system that are tied to their identities and include information about the users, such as interests and demographic information. The users may be individuals or entities such as corporations or charities. Content items are presented to various users by the online system to encourage users to interact with the online system.

Additionally, entities (e.g., a business) may present content items to online system users to gain public attention for products or services or to persuade online system users to take an action regarding products or services provided by the entity. An entity may create a campaign including multiple content items for presentation to users of the online system, where content items in a campaign may be associated with different targeting criteria to allow presentation of different content items in the campaign to online system users having different characteristics. Many online systems may receive compensation from an entity for presenting certain types of content items provided by the entity to online system users. Frequently, online systems charge an entity for each presentation of certain types of content to an online system user (e.g., each “impression” of the content) or for each interaction with the certain types of content by online system users.

However, a conventional online system does not provide entities compensating the online system for presentation of content items with information describing performance of the entity's content items relative to content items for which the online system receives compensation from other entities for presenting. For example, an entity associates an objective with presentation of certain content items, such as indicating a preference for the content items, installing an application identified by the content items, or sharing the content items with online system users, and the online system presents the content items to online system users. However, the online system does not provide the entity with information describing performance of presentation of the content items relative to content items from other entities associated with the same objective. This lack of information describing performance of the content items relative to other, similar content items may limit the entity's ability to effectively promote its content items.

### SUMMARY

An online system, such as a social networking system, receives advertising campaigns associated with various advertisers. Each advertising campaign includes one or more advertisements and may also include one or more objectives. An objective included in an advertising campaign identifies an interaction an advertiser associated with the advertising campaign desires users to perform when presented with advertisements included in the advertising campaign. Example objectives include: installing an application associated with an advertisement in an advertising campaign, indicating a preference for an advertisement included in the advertising campaign, sharing an advertisement included in the advertising campaign, interacting with an object associated with an advertisement in the advertising campaign, or performing any other suitable interaction. As advertisements from an advertising campaign are presented to online system users, the online system logs interactions between users presented with advertisements from the advertising campaign or with objects associated with advertisements from the advertising campaign. Additionally, the online system receives compensation from an advertiser as online system users perform interactions with advertisements in an advertising campaign that satisfy the objective included in the advertising campaign.

To allow an advertiser to identify advertising campaigns effectively or ineffectively promoting an objective, the online system identifies an objective included in an advertising campaign and determines a number of times the objective has been completed (a number of “completed objectives”) by online system users presented with advertisements from the advertising campaign. Information maintained by the online system and describing prior interactions with content by online system users is used to determine the number of completed objectives associated with the advertising campaign. In one embodiment, the online system identifies users who have been presented with one or more advertisements from the advertising campaign and retrieves information maintained by the online system identifying prior actions by the identified users. The online system determines the number of completed objectives associated with the advertising campaign based on a number of prior actions associated with identified users matching or associated with the objective included in the advertising campaign that includes the advertisements. For example, the number of completed objectives associated with the advertising campaign is the number of prior actions associated with users previously presented with an advertisement in the advertising campaign who performed an interaction matching the objective in the advertising campaign within a threshold time of being presented with the advertisement in the advertising campaign.

The online system also determines an amount of compensation received from an advertiser associated with the advertising campaign for presentation of advertisements included in the advertising campaign. As the advertiser compensates the online system for presentation of advertisements included in the advertising campaign (e.g., for presenting advertisements, for user interactions with presented advertisements), the amount received by the online system for presentation of advertisements included in the advertising campaign identifies an amount the advertiser has spent on the advertising campaign. Based on the amount of compensation received from the advertiser for presentation of advertisements included in the advertising campaign and the number of completed objectives associated with the advertising campaign, the online system determines a metric associated with the advertising campaign. In various embodiments, the metric is a ratio of the number of completed objectives associated with the advertising campaign to the amount of compensation received from the advertiser for presentation of advertisements included in the advertising campaign. Hence, the metric may provide a measure of the cost to the advertiser per completed objective associated with the advertising campaign.

Additional advertising campaigns may be defined as multiple advertising campaigns from one advertiser or one or more advertising campaigns from additional advertisers. Additional advertising campaigns including the objective in the advertising campaign or including objectives identified as matching or similar to the objective in the advertising campaign are identified by the online system, which computes additional metrics for at least a set of the additional advertising campaign. An additional metric for an additional advertising campaign is determined from a number of completed objectives associated with the additional advertising campaign and an amount of compensation received by the online system for presenting advertisements included in the additional advertising campaign, determined as described above. Based on the metric for the advertising campaign and the additional metrics for the additional advertising campaign, the online system determines information describing performance of the advertising campaign. For example, the online system ranks the advertising campaign and the additional advertising campaigns based on the metric and the additional metrics and determines performance of the advertising campaign relative to the additional advertising campaigns based on the ranking. A message describing performance of the advertising campaign may be communicated to the advertiser associated with the advertising campaign in some embodiments. For example, the message is communicated to the advertiser if the advertising campaign has at least a threshold position in the ranking, and may include a recommendation to the advertiser to increase a budget of the advertising campaign or to extend a duration during which advertisements from the advertising campaign are presented. Alternatively, the online system communicates the message to the advertiser if the advertising campaign has less than a threshold position in the ranking, allowing the advertiser to identify advertising campaigns performing poorly relative to other, similar advertising campaigns. In other embodiments, the online system may perform one or more actions based on the advertisement campaign's position in the ranking. For example, the online system may increase a duration during which advertisements from an advertising campaign are presented by the online system if the advertising campaign has at least a threshold position in the ranking.

### BRIEF DESCRIPTION OF THE DRAWINGS

FIG. 1 is a block diagram of a system environment in which an online system operates, in accordance with some embodiments.

FIG. 2 is a block diagram of an online system, in accordance with some embodiments.

FIG. 3 is a block diagram of an advertising campaign maintained by an online system, in accordance with one embodiment.

FIG. 4 is a flowchart of a method for determining a performance of an advertising campaign based on an objective included in the advertising campaign, in accordance with some embodiments.

FIGS. 5A and 5B are examples of user interfaces describing performance of an advertising campaign, in accordance with some embodiments.

FIG. 6 is an example graph showing metrics for performance of different advertising campaigns over time, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

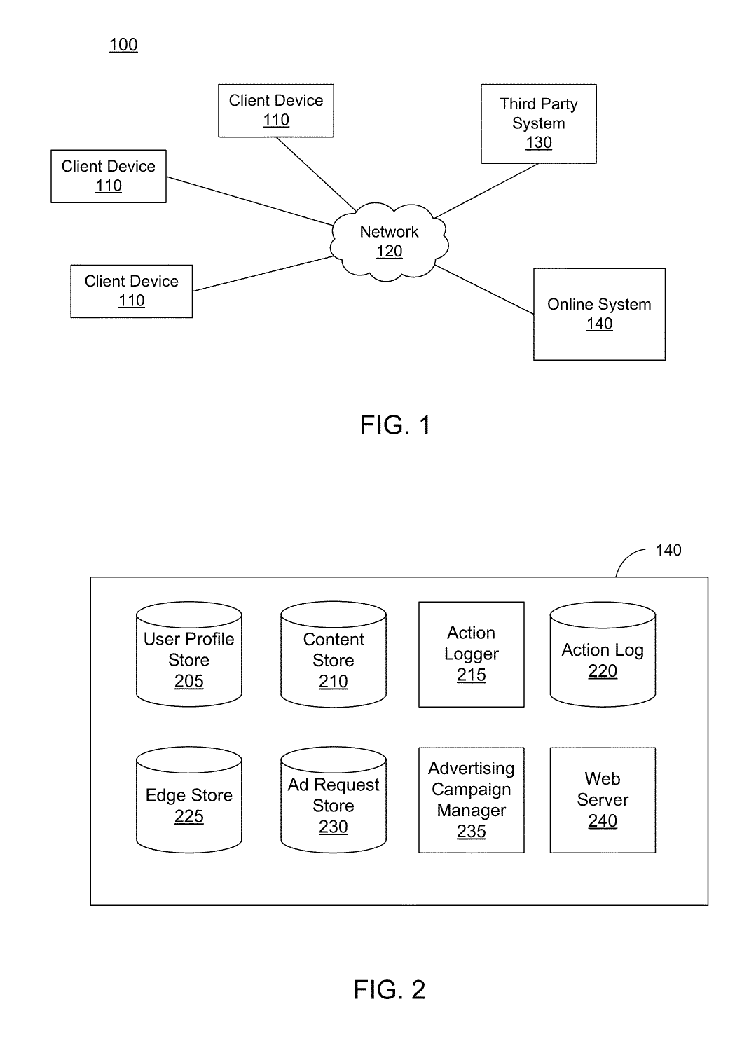

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. In some embodiments, the online system 140 is a social networking system. The online system 140 shown in FIG. 2 includes a user profile store 205, a content store 210, an action logger 215, an action log 220, an edge store 225, an advertisement (“ad”) request store 230, an advertising campaign manager 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions (or “interactions”) internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of the online system 140 through a plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action log 220 by the application for recordation and association with the user by the online system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content (also referred to as “an advertisement”) and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

Additionally, an ad request may also include an objective specifying a goal of the advertiser for presentation of the advertisement content in the ad request to online system users. For example, the objective identifies a type of interaction with the advertisement content or with an object associated with the advertisement content by online system users presented with the advertisement content. Examples of objectives include: online system users accessing presented advertisement content (e.g., clicking or otherwise accessing the advertisement content), online system users installing an application associated with an ad request, online system users expressing a preference for a page or other object associated with the ad request (i.e., “liking” the page), online system users viewing a page or other object associated with the ad request, or any other suitable action by online system users.

One or more ad requests may include a duration specifying a time interval during which the advertisement content in an ad request is presented to online system users. The duration may be specified by an advertiser associated with an ad request or may be determined by the online system 140. For example, a duration included in an ad request specifies a number of days during which advertisement content in the ad request is eligible for presentation to online system users (e.g., users having at least a threshold number of characteristics satisfying targeting criteria included in the ad request). As another example, a duration included in an ad request specifies a range of times or dates during which advertisement content in the ad request is eligible for presentation to online system users.

The ad request store 230 may include one or more advertising campaigns. An advertising campaign includes a plurality of ad requests for presentation to online system users and is associated with an advertiser. Additionally, an advertising campaign may include one or more characteristics that are included in each ad request included in the advertising campaign. For example, an advertising campaign includes an objective, and the objective is included in each ad request that is included in the advertising campaign. As another example, an advertising campaign includes a duration specifying a time interval during which ad requests in the advertising campaign are eligible for presentation to online system users, so each ad request in the advertising campaign includes the duration. Additional information may be included in an advertising campaign. For example, the advertising campaign includes a budget that specifies a total amount of compensation an advertiser associated with the advertising campaign provides the online system 140 for presenting advertisement content from ad requests included in the advertising campaign. The budget may be allocated for the advertising campaign as a whole or per ad request in the advertising campaign. In addition, the advertiser may specify instructions for allocating the budget among different ad requests in the advertising campaign. For example, instructions specify modification of a bid amount included in an ad request over time or based on other criteria. The instructions may include other suitable information describing allocation of budget among ad requests included in the ad campaign.

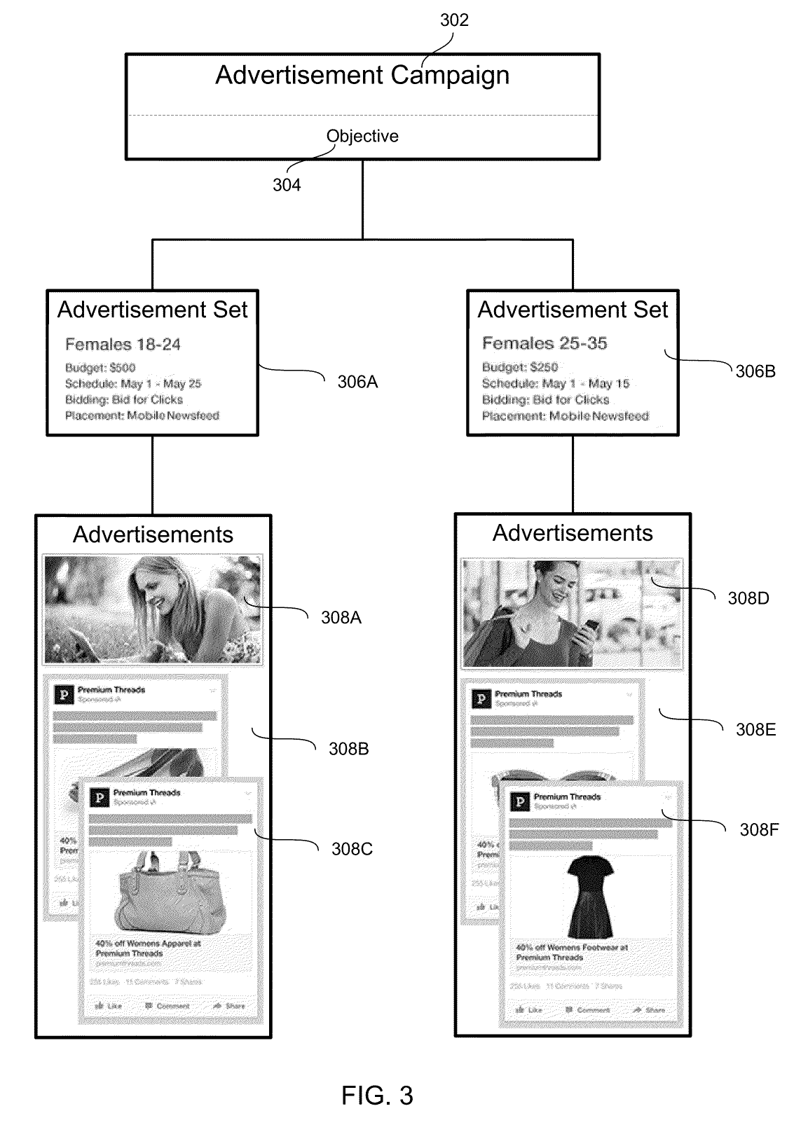

FIG. 3 shows an example of an advertising campaign included in the ad request store 230. In the example of FIG. 3, an advertising campaign 302 includes an objective 304, multiple sets of targeting criteria 306A, 306B (also referred to individually and collectively using reference number 306), and various ad requests 308A, 308B, 308C, 308D, 308E, 308F (also referred to individually and collectively using reference number 308). Rather than include targeting criteria in each ad request 308, the advertising campaign 306 shown in FIG. 3 associates multiple ad requests 308 with a set of targeting criteria 306, with the targeting criteria in a set of targeting criteria 306 identifying characteristics of users eligible to be presented with ad requests 308 associated with the set of targeting criteria 306. In the example of FIG. 3, ad requests 308A, 308B, 308C are eligible for presentation to online system users satisfying at least a threshold number of the targeting criteria in the set of targeting criteria 306A (i.e., users with a gender of female and an age between 18-24 years old). Similarly, ad requests 308D, 308E, 308F in FIG. 3 are eligible for presentation to online system users satisfying at least a threshold number of the targeting criteria in the set of targeting criteria 306B.

As described above in conjunction with FIG. 2, the objective 306 included in the advertising campaign 302 specifies a goal of the advertiser for presentation of advertisement content in ad requests 308 included in the advertising campaign 302 to online system users. For example, the objective identifies a type of interaction with advertisement content from ad requests 308 included in the advertising campaign 302 or a type of interaction with objects associated with ad requests 308 in the advertising campaign 302. Examples of objectives include: online system users accessing presented advertisement content (e.g., clicking or otherwise accessing the advertisement content), online system users installing an application associated with an ad request, online system users expressing a preference for a page or other object associated with the ad request (i.e., “liking” the page), online system users viewing a page or other object associated with the ad request, or any other suitable action by online system users. In some embodiments, the ad campaign 302 includes multiple objectives 304 associated with various ad requests 308 included in the ad campaign 302. For example, a set of targeting criteria 306 also includes an objective, so ad requests 308 associated with the set of targeting criteria 306 include the objective included in the set of targeting criteria 306. Thus, different groups of ad requests 308 in the advertising campaign 302 may include different objectives to provide an advertiser associated with the advertising campaign 302 to promote different interactions by various users (e.g., users satisfying different targeting criteria).

Additionally, a budget may be associated with the advertising campaign 302 specifying a total amount of compensation an advertiser associated with the advertising campaign 302 provides the online system for presenting advertisement content from ad requests 308 included in the advertising campaign 302. Portions of the budget may be allocated to different ad requests 308 in the advertising campaign 302 or to different groups of ad requests included in the advertising campaign 302. For example, in FIG. 3, $500 of the budget of the advertising campaign 302 is allocated to presentation of ad requests 308A, 308B, 308C, which are associated with set of targeting criteria 306A, while $250 of the budget of the advertising campaign 302 is allocated to presentation of ad requests 308D, 308E, 308F, which are associated with set of targeting criteria 306B. In some embodiments, durations are associated with different ad requests 308 included in the advertising campaign 302, allowing an advertiser to regulate presentation of various ad requests 308. For example, different sets of targeting criteria 306 are associated with different durations, so an ad request 308 is presented for a duration specified by a duration associated with a set of targeting criteria 306 associated with the ad request 308.

Referring back to FIG. 2, the advertising campaign manager 235 determines one or more metrics describing performance of an advertising campaign included in the ad request store 230. To more accurately evaluate performance of an advertising campaign, the advertising campaign manager 235 identifies an objective included in an advertising campaign and identifies additional advertising campaigns also including the objective or including objectives matching or similar to the objective. The additional advertising campaigns may be defined as multiple advertising campaigns from one advertiser or one or more advertising campaigns from additional advertisers. This allows the advertising campaign manager 235 to evaluate the advertising campaign relative to other advertising campaigns with a matching or similar objective, allowing more accurate modification of one or more characteristics of the advertising campaign based on its performance.

After identifying an objective included in an advertising campaign, the advertising campaign manager 235 identifies online system users who have previously been presented with advertisement content from ad request included in the advertising campaign and retrieves prior interactions by the identified online system users with advertisement content from one or more ad requests included in the advertising campaign or with objects associated with advertisement content from one or more ad requests included in the advertising campaign from the action log 220. Based on the prior interactions by the identified users, the advertising campaign manager 235 identifies interactions by the identified users that satisfy the identified objective to determine a number of completed objectives associated with the advertising campaign. In one embodiment, an interaction satisfies an objective of the advertising campaign if the interaction matches the objective of the advertising campaign and was performed within a threshold time of presentation of advertisement content in the advertising campaign. For example, if the advertising campaign's objective is installation of an application identified by ad requests in the advertising campaign, the advertising campaign manager 235 determines a number of online system users who were presented with advertisement content from an ad request in the advertising campaign and who installed the application within a threshold time of being presented with the advertisement content from the ad request; in this example, the number of completed objectives associated with the advertising campaign is the number of users who installed the application within the threshold time of being presented with advertisement content from the advertising campaign.

Additionally, the advertising campaign manager 235 determines an amount of compensation the online system 140 received from an advertiser associated with the advertising campaign for presentation of advertisement content included in the advertising campaign. The amount of compensation may be determined from a time when the advertising campaign was received to a current time or may be determined during a specified time interval when advertisement content from the advertising campaign was presented by the online system 140. In some embodiments, when compensation is received from an advertiser, information describing the compensation (e.g., an amount, an advertising campaign associated with the compensation) is included in a user profile associated with the advertiser and included in the user profile store 205.

Based on the number of completed objectives associated with the advertising campaign and the amount of compensation received from the advertiser associated with the advertising campaign for presentation of advertisement content included in the advertising campaign, the advertising campaign manager 235 determines a metric for the advertising campaign. In various embodiments, the metric is a ratio of the number of completed objectives associated with the advertising campaign to the amount of compensation received from the advertiser for presentation of advertisement content included in the advertising campaign. Hence, the metric may provide a measure of the cost to the advertiser per completed objective associated with the advertising campaign. However, in other embodiments, any suitable metric may be determined based at least in part on the number of completed objectives associated with the advertising campaign and the amount of compensation received from the advertiser associated with the advertising campaign for presentation of advertisement content included in the advertising campaign.

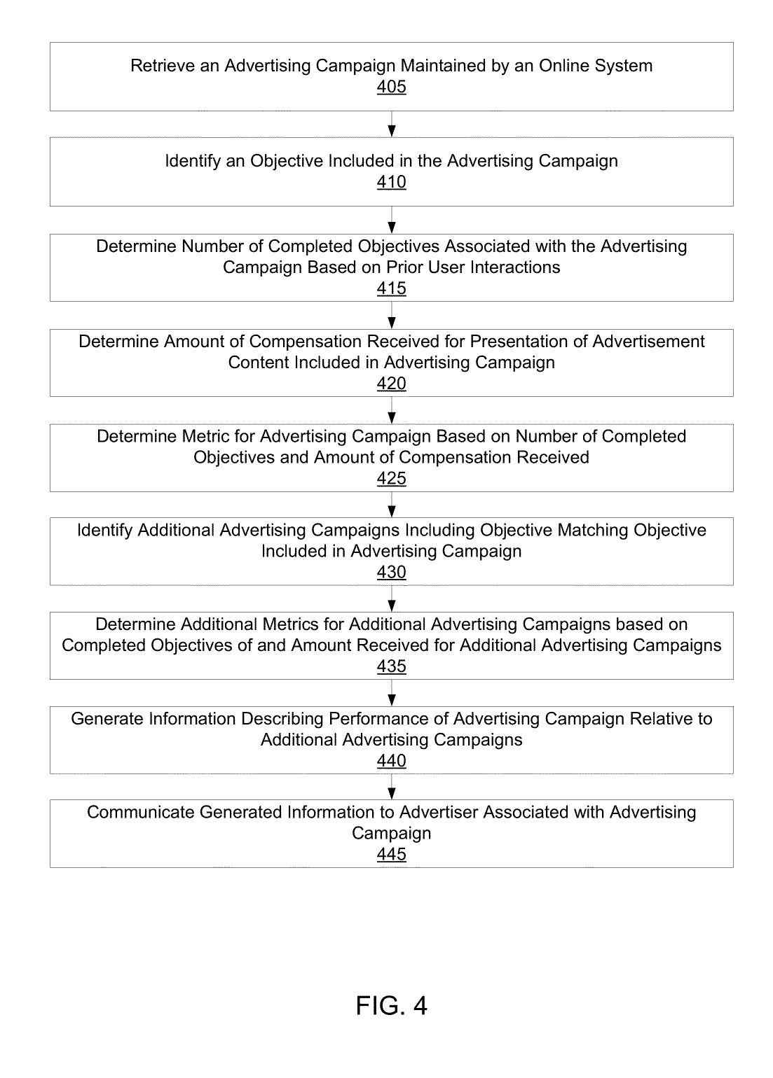

The advertising campaign manager 235 determines additional metrics for one or more of the additional advertising campaigns also including the objective or including objectives matching or similar to the objective included in the advertising campaign. As described above, the advertising campaign manager 235 determines a number of completed objectives associated with an additional advertising campaign based on prior interactions by users previously presented with advertisement content from the additional advertising campaign and on an amount of compensation received by the online system 140 from an advertiser for presentation of advertisement content included in the additional advertising campaign. Based on a comparison of the metric for the advertising campaign to the additional metrics, the advertising campaign manager 235 determines a performance of the advertising campaign relative to the additional advertising campaigns including objectives matching or similar to the objective included in the advertising campaign. Based on the comparison, the online system 140 may perform one or more actions, such as communicating a message to the advertiser associated with the advertising campaign to modify the advertising campaign. Determining the metric and determining performance of the advertising campaign relative to the additional advertising campaigns including objectives matching or similar to the objective included in the advertising campaign is further described below in conjunction with FIG. 4.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Determining Advertising Campaign Performance Based on Advertising Campaign Objective

FIG. 4 is a flowchart of one embodiment of a method for determining a performance of an advertising campaign based on an objective included in the advertising campaign. In other embodiments, the method may include different and/or additional steps than those described in conjunction with FIG. 4. Additionally, steps of the method may be performed in different orders than the order described in conjunction with FIG. 4 in some embodiments.

The online system 140 retrieves 405 an advertising campaign maintained by the online system 140 and identifies 410 an objective included in the advertising campaign. For example, the online system 140 receives a selection of the advertising campaign including an identifier of the advertising campaign from an advertiser associated with the advertising campaign and retrieves 405 information associated with the advertising campaign. If the advertising campaign includes multiple objectives, the online system 140 may prompt the advertiser to identify 410 an objective, may identify 410 an objective associated with a maximum number or percentage of ad requests included in the advertising campaign, or may identify 410 an objective based on any other suitable criteria. As described above in conjunction with FIGS. 2 and 3, an objective specifies a goal of the advertiser for presentation of advertisement content in ad requests included in the advertising campaign to users. Examples of objectives include: online system users accessing presented advertisement content (e.g., clicking or otherwise accessing the advertisement content), online system users installing an application associated with an ad request, online system users expressing a preference for a page or other object associated with the ad request (i.e., “liking” the page), online system users viewing a page or other object associated with the ad request, or any other suitable action by online system users. In some embodiments, the online system 140 retrieves 405 an advertising campaign based on any suitable criteria (e.g., passing of a threshold amount of time after receiving the advertising campaign or presenting advertisement content from the advertising campaign for at least a threshold length of time, receiving the advertising campaign at a specified time) or retrieves 405 different advertising campaigns at different times.

Based on prior interactions by users previously presented with advertisement content from the advertising campaign, the online system 140 determines 415 a number of completed objectives associated with the advertising campaign. The online system 140 identifies users who were presented with advertisement content from the advertising campaign and retrieves prior interactions associated with the identified users. In some embodiments, the online system 140 identifies users who were presented with advertisement content from the advertising campaign within a threshold time from a current time or identifies users who were presented with advertisement content from the advertising campaign during a particular time interval. For various identified users, the online system determines if one or more interactions performed by an identified user after being presented with advertisement content from the advertising campaign match the identified objective included in the advertising campaign. In some embodiments, the online system 140 determines whether each identified user is associated with one or more interactions associated with a time after presentation of advertisement content to an identified user and matching the identified objective included in the advertising campaign. Each interaction by an identified user matching the identified objective included in the advertising campaign and associated with a time after presentation of advertising content to the identified user is identified as a completed objective, and the online system 140 determines 415 the number of completed objectives that are identified for association with the advertising campaign. In some embodiments, the number of completed objectives is determined 415 for a specified time interval. Alternatively, the number of completed objectives is determined 415 from a time between receipt of the advertising campaign by the online system 140 (or from initial presentation of advertisement content from the advertising campaign to online system users) to a current time.

Additionally, the online system 140 determines 420 an amount of compensation received by the online system 140 from the advertiser associated with the advertising campaign for presentation of advertisement content from the advertising campaign. The amount of compensation may be determined 420 from a time when the advertising campaign was received by the online system 140 or from a time when advertising content from the advertising campaign was initially presented to a current time or may be determined during a specified time interval when advertisement content from the advertising campaign was presented by the online system 140. In some embodiments, the amount of compensation is retrieved from information associated with the advertiser by the online system 140. Alternatively, the online system 140 may request the amount of compensation from a third party system 130 associated with the advertiser.

Based on the number of completed objectives associated with the advertising campaign and the amount of compensation received from the advertiser associated with the advertising campaign for presentation of advertisement content included in the advertising campaign, the online system 140 determines 425 a metric for the advertising campaign. For example, the metric is a ratio of the number of completed objectives associated with the advertising campaign to the amount of compensation received from the advertiser for presentation of advertisement content included in the advertising campaign. Thus, in various embodiments, the metric provides a measure of the cost to the advertiser per completed objective associated with the advertising campaign. In some embodiments, the online system 140 determines 425 various metrics for different time intervals based on numbers of completed objectives and amounts of compensation received from the advertiser for presentation of advertisement content from the advertising campaign during the different time intervals. Additionally, the online system 140 may determine 425 suitable metric based at least in part on the number of completed objectives associated with the advertising campaign and the amount of compensation received from the advertiser associated with the advertising campaign for presentation of advertisement content included in the advertising campaign.

The online system 140 also identifies 430 additional advertising campaigns that include the objective included in the advertising campaign or that include a similar objective to the objective included in the advertising campaign and determines 430 additional metrics for at least a set of the additional advertising campaigns. In some embodiments, the online system 140 maintains information associating one or more alternative objectives with an objective, and identifies 430 an additional advertising campaign including an alternative objective as including an objective similar to the objective included in the advertising campaign. For at least a set of the additional advertising campaigns, the online system 140 determines 435 additional metrics. In some embodiments, the online system 140 determines 435 an additional metric for each additional advertising campaign or for each additional advertising campaign in a set. For example, the online system 140 determines 435 an additional metric for each additional advertising campaign having a duration matching a duration included in the advertising campaign or for each additional advertising campaign received by the online system 140 within a threshold time of the online system 140 receiving the advertising campaign. To determine 435 an additional metric for an additional advertising campaign, the online system 140 determines a number of completed objectives associated with the additional advertising campaign, as described above, and determines an amount of compensation received by the online system 140 from an advertiser for presentation of advertisement content included in the additional advertising campaign, as described above; for example, the additional metric for an additional advertising campaign is a ratio of the number of completed objectives associated with the additional advertising campaign to the amount of compensation received by the online system 140 from an advertiser for presentation of advertisement content included in the additional advertising campaign.

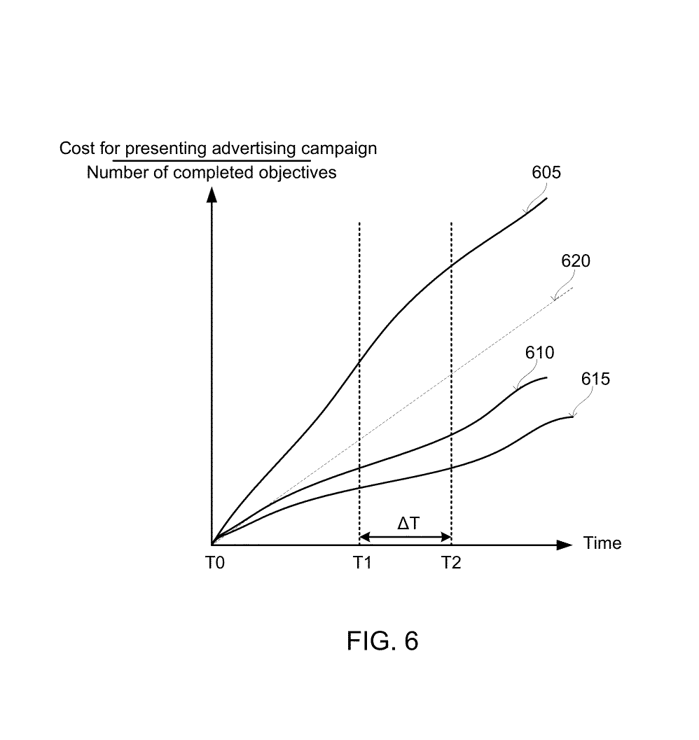

Based on a comparison of the metric for the advertising campaign to the additional metrics, the online system 140 generates 440 information describing performance of the advertising campaign relative to the additional advertising campaigns. In some embodiments, the online system 140 ranks the advertising campaign and the additional advertising campaigns based on the metric and the additional metrics. If the advertising campaign has at least a threshold position in the ranking, the online system 140 generates 440 information indicating the advertising campaign is outperforming the additional advertising campaigns. Alternatively, the online system 140 generates 440 information indicating the advertising campaign is underperforming if the advertising campaign has less than a threshold position in the ranking. In other embodiments, the online system 140 generates 440 information identifying a position of the advertising campaign in the ranking. In some embodiments, the online system 140 generates 440 information describing values of the metric for the advertising campaign at different times and information describing values of additional metrics for one or more additional advertising campaigns, without identifying the advertising campaigns. Additionally, the online system 140 may generate 440 additional information describing changes in performance of the advertising campaign based on changes in the metric over time. For example, the online system 140 determines a rate of change of the metric over various time intervals and generates information indicating a time when the rate of change is less than a threshold value or is greater than a threshold value. As another example, the online system 140 also determines when the number of completed objectives equals or exceeds a threshold value. The online system 140 may also receive or determine threshold values of the metric for the advertising campaign at different times and compare the metric to the threshold values at different times, such as described below in conjunction with FIG. 6.

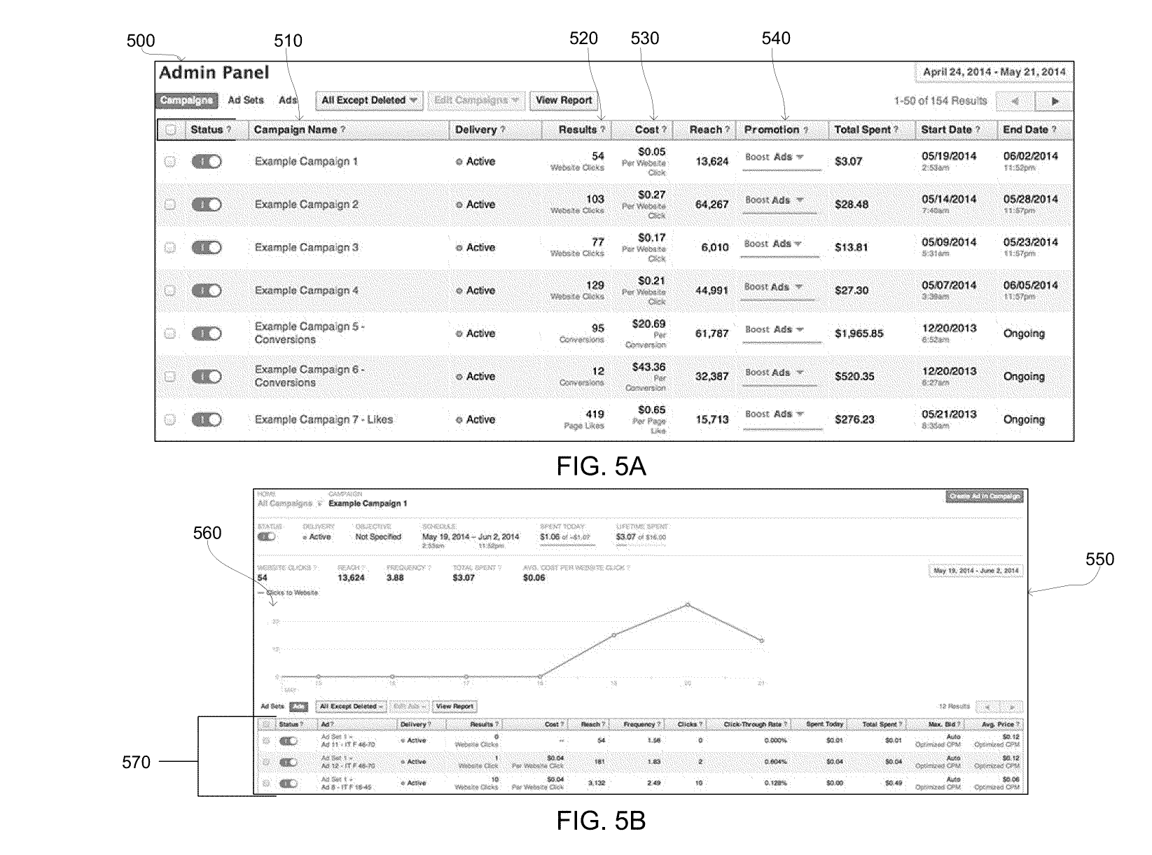

In some embodiments, the online system 140 communicates 445 the generated information to the advertiser associated with the advertising campaign. For example the generated information is communicated 445 to the advertiser via one or more user interfaces, such as those described below in conjunction with FIGS. 5A and 5B. In another embodiment, the online system 140 communicates 445 the information to the advertiser via any suitable communication channel (e.g. a text message, a push notification presented in an application associated with the online system 140 on a client device 110, an e-mail, etc.). The advertiser may specify one or more criteria so the information is communicated 445 to the advertiser when the information satisfies at least a threshold number of the criteria. For example, if the criteria indicates the advertising campaign has a higher position in the ranking than at least a threshold number or percentage of the additional advertising campaigns, the information is communicated 445 to the advertiser. As another example, if the criteria indicates the advertising campaign has a lower position in the ranking than greater than a threshold number or percentage of the additional advertising campaigns, the information is communicated 445 to the advertiser. Similarly, criteria may specify characteristics of the metric itself, such as a threshold rate of change of the metric that, when satisfies, causes communication 445 of the information generated 440 by the online system 140 to the advertiser. Alternatively, the online system 140 communicates 445 the information to the advertiser as the information is generated 440 or communicates 445 the information to the advertiser at periodic intervals.

Based on the information from the online system 140, the advertiser may modify the advertising campaign. For example, if the information indicates the advertising campaign is outperforming at least a threshold number or percentage of the additional advertising campaigns, the advertiser may increase the budget or the duration of the advertising campaign to increase the amount of advertisement content from the advertising campaign presented by the online system. As another example, if the information indicates the advertising campaign is performing worse than least a threshold number or percentage of the additional advertising campaigns, the advertiser may remove the advertising campaign or reduce the duration or budget of the advertising campaign to mitigate potential losses in revenue from continuing to present the advertising campaign. In some embodiments, the advertiser may provide rules to the online system 140 along with the advertising campaign, with a rule specifying one or more criteria based on the metric for the advertising campaign and one or more actions to perform if the criteria are satisfied. For example, a rule specifies a threshold number or percentage of additional advertising campaigns having positions in the ranking lower than a position of the advertising campaign and increases a budget of the advertising campaign by a specified amount if the threshold number or percentage of additional advertising campaigns have positions in the ranking lower than the position of the advertising campaign.

While FIG. 4 describes generation of a metric for an advertising campaign and determining performance of the advertising campaign relative to additional advertising campaigns including the objective included in the advertising campaign or including an objective similar to the objective included in the advertising campaign, the steps described above in conjunction with FIG. 4 may be used to generate and to determine performance of different types of objects. For example, an objective included in an ad request may be identified and used by the online system 140 to determine a metric for the ad request based on completed objectives and an amount of compensation received by the online system 140 for presentation of the ad request, as described above ion conjunction with FIG. 4; additional ad requests including the objective are identified and, as described above in conjunction with FIG. 4, additional metrics for various additional ad requests are determined based on completed objectives associated with additional ad requests and amounts of compensation received for presentation of the additional ad requests. As described above, the metric and the additional metrics are used to describe performance of the ad request. Performance of other objects, such as pages or posts of content may be similarly determined.

FIG. 5A is an example of information communicated to an advertiser by an online system 140 describing performance of various advertising campaigns associated with an advertiser. In the example of FIG. 5A, an advertising campaign management interface 500 is communicated to the advertiser by the online system 140. The advertising campaign management interface 500 includes identifiers 510 of one or more advertising campaigns associated with the advertiser, a number of completed objectives 520 associated with each of the advertising campaigns, and metrics 530 for each of the advertising campaigns. In the example of FIG. 5A, the metric 530 for an advertising campaign is a ratio of completed objectives to an amount spent by the advertiser for presentation of advertisement content in the advertising campaign. The advertising campaign management interface 500 may also include an option 540 for the advertiser to modify various advertising campaigns. In some embodiments, a user associated with the advertiser accesses an option 540 associated with an advertising campaign to modify the advertising campaign (e.g., modify a duration of the advertising campaign, modify a budget of the advertising campaign). One or more advertising campaigns may be visually distinguished from other advertising campaigns based at least in part on the metric for the advertising campaign. For example, advertising campaigns having metrics with a threshold position in a ranking of the metric and additional metrics for additional advertising campaigns including the objective are visually distinguished from other advertising campaigns in the advertisement campaign management interface 500. As shown in FIG. 5A, additional information associated with various advertising campaigns may also be included in the advertising campaign management interface 500.

FIG. 5B is an example of an alternative advertisement campaign management interface 550 that presents information describing performance of an advertising campaign. The advertisement campaign management interface 550 may be presented after selecting a specific advertising campaign from the advertisement campaign management interface 500 and presents additional information about the specific advertising campaign. In the example of FIG. 5B, the advertisement campaign management interface 550 presents a graphical representation 560 of a number of completed objectives associated with the advertising campaign over time. However the advertisement campaign management interface 550 may also present a graphical representation of the metric for the advertising campaign over time. Additionally, the advertisement campaign management interface 550 presents information 570 describing various groups of ad requests or individual ad requests included in the specific advertising campaign (e.g., completed objectives associated with various ad requests, metrics associated with various ad requests, amounts received by the online system 140 for presentation of various ad requests).

### Example Metrics for an Advertising Campaign

FIG. 6 is an example graph showing metrics for different advertising campaigns over time. In the example of FIG. 6, a metric that is a ratio of cost for presenting an advertising campaign to a number of completed objectives for the advertising campaign is shown at different times for different advertising campaigns 605, 610, 615. Values for the metric for each advertising campaign 605, 610, 615 are shown for different times starting from a time when at least one of the advertising campaigns 605, 610, 615 were received by the online system 140 or from a time when content from at least one of the advertising campaigns 605, 610, 615 was presented by the online system 140.

In some embodiments, an advertiser may specify one or more threshold values for the metric for an advertising campaign, and the online system 140 may provide information to the advertiser based on a comparison of the metric for an advertising campaign to the threshold values. The threshold values may be specified based on metrics for additional advertising campaigns including an objective included in the advertising campaign associated with the advertiser or may be based on any other suitable criteria. For example, FIG. 6 shows an example where the threshold values 620 for the metric specified by an advertiser change over time. If an advertiser associated with the advertising campaign 610 specifies the threshold values 620 in FIG. 6, the online system 140 indicates to the advertiser that the advertising campaign 610 is performing worse than the specified threshold values 620. The advertiser may delete the advertising campaign 610 based on the indication or perform any other suitable action. However, if an advertiser associated with the advertising campaign 605 specifies the threshold values 620, the online system 140 indicates to the advertiser that the advertising campaign 605 is performing better than the specified threshold values 620. Based on the indication, the advertiser may increase a budget of the advertising campaign 605, increase a duration for the advertising campaign 605, or perform any other suitable interaction.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
retrieving an advertising campaign maintained by an online system, the advertising campaign including advertisement content and one or more objectives, the advertising campaign associated with an advertiser;
identifying an objective included in the advertising campaign;
determining a number of completed objectives associated with the advertising campaign based on prior interactions between users of the online system and the one or more advertisements included in the advertising campaign maintained by the online system;
determining a cost to the advertiser for the advertising campaign based on an amount of compensation received by the by the online system from the advertiser for presentation of the advertisement content included in the advertising campaign;
determining a metric for the advertising campaign based at least in part on the cost to the advertiser for the advertising campaign and on the number of completed objectives associated with the advertising campaign;
identifying one or more additional advertising campaigns each associated with the objective of the advertising campaign;
determining additional metrics for at least a set of the additional advertising campaigns, an additional metric associated with an additional advertising campaign based at least in part on a number of completed objectives associated with the additional advertising campaign and based on the amount of revenue associated with the additional advertising campaign;
determining a relative performance of the advertising campaign to the additional advertising campaigns based at least in part on the metric for the advertising campaign and on the additional metrics for the set of the additional advertising campaigns; and
communicating information to the advertiser associated with the advertising campaign based at least in part on the determined relative performance of the advertising campaign.

2. The method of claim 1, wherein determining the relative performance of the advertising campaign to the additional advertising campaigns based at least in part on the metric for the advertising campaign and on the additional metrics for the set of the additional advertising campaigns comprises:
ranking the advertising campaign and the additional advertising campaigns based on the metric for the advertising campaign and on the additional metrics for the set of the additional advertising campaigns.

3. The method of claim 2, wherein communicating information to the advertiser associated with the advertising campaign based at least in part on the determined relative performance of the advertising campaign comprises:
communicating information to the advertiser if the advertising campaign has at least a threshold position in the ranking.

4. The method of claim 3, wherein the information describes the relative performance of the advertising campaign to one or more of the additional advertising campaigns.

5. The method of claim 2, wherein communicating information to the advertiser associated with the advertising campaign based at least in part on the determined relative performance of the advertising campaign comprises:
communicating information to the advertiser if the advertising campaign has less than a threshold position in the ranking.

6. The method of claim 5, wherein the information describes the relative performance of the advertising campaign to one or more of the additional advertising campaigns.

7. The method of claim 1, wherein the information specifies a rate of change of the metric for the advertising campaign during one or more time intervals.

8. The method of claim 1, wherein determining the metric for the advertising campaign based at least in part on the cost to the advertiser for the advertising campaign and on the number of completed objectives associated with the advertising campaign comprises:
determining a ratio of the cost to the advertiser for the advertising campaign to the number of completed objectives associated with the advertising campaign.

9. The method of claim 1, wherein determining additional metrics for at least the set of the additional advertising campaigns comprises:
selecting an additional advertising campaign from the set;
determining an additional metric for the selected additional advertising campaign as a ratio of an amount of compensation received by the online system for the selected additional advertising campaign to a number of completed objectives associated with the selected additional advertising campaign.

10. A method comprising:
retrieving an advertising campaign maintained by an online system, the advertising campaign including advertisement content and one or more objectives, the advertising campaign associated with an advertiser;
identifying an objective included in the advertising campaign;
determining a number of completed objectives associated with the advertising campaign based on prior interactions between users of the online system and the one or more advertisements included in the advertising campaign maintained by the online system;
determining a cost to the advertiser for the advertising campaign based on an amount of compensation received by the by the online system from the advertiser for presentation of the advertisement content included in the advertising campaign;
determining a metric for the advertising campaign based at least in part on the cost to the advertiser for the advertising campaign and on the number of completed objectives associated with the advertising campaign;
identifying one or more additional advertising campaigns each associated with the objective of the advertising campaign;
determining additional metrics for at least a set of the additional advertising campaigns, an additional metric associated with an additional advertising campaign based at least in part on a number of completed objectives associated with the additional advertising campaign and based on the amount of revenue associated with the additional advertising campaign; and
generating information describing a relative performance of the advertising campaign to the additional advertising campaigns based at least in part on the metric for the advertising campaign and on the additional metrics for the set of the additional advertising campaign.

11. The method of claim 10, wherein generating the information describing the relative performance of the advertising campaign to the additional advertising campaigns based at least in part on the metric for the advertising campaign and on the additional metrics for the set of the additional advertising campaigns comprises:
ranking the advertising campaign and the additional advertising campaigns based on the metric for the advertising campaign and on the additional metrics for the set of the additional advertising campaigns.

12. The method of claim 11, wherein generating the information describing the relative performance of the advertising campaign to the additional advertising campaigns based at least in part on the metric for the advertising campaign and on the additional metrics for the set of the additional advertising campaigns further comprises:
generating information indicating whether the advertising campaign has at least a threshold position in the ranking.

13. The method of claim 11, wherein generating the information describing the relative performance of the advertising campaign to the additional advertising campaigns based at least in part on the metric for the advertising campaign and on the additional metrics for the set of the additional advertising campaigns comprises:
generating information indicating whether the advertising campaign has less than a threshold position in the ranking.

14. The method of claim 10, wherein the generated information specifies a rate of change of the metric for the advertising campaign during one or more time intervals.

15. The method of claim 10, wherein determining the metric for the advertising campaign based at least in part on the cost to the advertiser for the advertising campaign and on the number of completed objectives associated with the advertising campaign comprises:
determining a ratio of the cost to the advertiser for the advertising campaign to the number of completed objectives associated with the advertising campaign.

16. The method of claim 10, wherein determining additional metrics for at least the set of the additional advertising campaigns comprises:
selecting an additional advertising campaign from the set;
determining an additional metric for the selected additional advertising campaign as a ratio of an amount of compensation received by the online system for the selected additional advertising campaign to a number of completed objectives associated with the selected additional advertising campaign.

17. The method of claim 10, further comprising:
performing one or more actions to the advertising campaign if the relative performance of the advertising campaign to the additional advertising campaigns satisfies one or more criteria specified by the advertiser.

18. The method of claim 17, wherein a criteria specified by the advertiser comprises the relative performance of the advertising campaign exceeding a threshold value.

19. A computer program product comprising a computer readable storage medium having instructions encoded thereon that, when executed by a processor, cause the processor to:
retrieve an advertising campaign maintained by an online system, the advertising campaign including advertisement content and one or more objectives, the advertising campaign associated with an advertiser;
identify an objective included in the advertising campaign;
determine a number of completed objectives associated with the advertising campaign based on prior interactions between users of the online system and the one or more advertisements included in the advertising campaign maintained by the online system;
determine a cost to the advertiser for the advertising campaign based on an amount of compensation received by the by the online system from the advertiser for presentation of the advertisement content included in the advertising campaign;
determine a metric for the advertising campaign based at least in part on the cost to the advertiser for the advertising campaign and on the number of completed objectives associated with the advertising campaign;
identify one or more additional advertising campaigns each associated with the objective of the advertising campaign;
determine additional metrics for at least a set of the additional advertising campaigns, an additional metric associated with an additional advertising campaign based at least in part on a number of completed objectives associated with the additional advertising campaign and based on the amount of revenue associated with the additional advertising campaign; and
generate information describing a relative performance of the advertising campaign to the additional advertising campaigns based at least in part on the metric for the advertising campaign and on the additional metrics for the set of the additional advertising campaign.

20. The computer program product of claim 19, wherein determine the metric for the advertising campaign based at least in part on the cost to the advertiser for the advertising campaign and on the number of completed objectives associated with the advertising campaign comprises:
determine a ratio of the cost to the advertiser for the advertising campaign to the number of completed objectives associated with the advertising campaign.
